(19) United States
(12) Patent Application Publication
(10) Pub. No.: US 2023/0292111 A1
(43) Pub. Date: Sep. 14, 2023

(54) METHOD FOR MANAGING IDENTITY BY A TRANSMITTING ENTITY IN A 3GPP MCS NETWORK

(71) Applicant: AIRBUS DS SLC, ELANCOURT (FR)

(72) Inventors: Louis GRANBOULAN, ELANCOURT (FR); Olivier PATEROUR, ELANCOURT (FR); François PIROARD, ELANCOURT (FR)

(21) Appl. No.: 18/180,522

(22) Filed: Mar. 8, 2023

(30) Foreign Application Priority Data
Mar. 8, 2022 (FR) 2201994

(51) Int. Cl. H04W 12/033; H04W 12/041

(52) U.S. Cl. CPC H04W 12/033; H04W 12/041

(57) ABSTRACT

A method implemented by a client transmitting entity included in a 3GPP MCS (3rd Generation Partnership Program Mission Critical Services) standard network, the client transmitting entity being configured to transmit a plurality of contents intended for at least one client receiving entity included in the network, the client transmitting entity and the client receiving entity being affiliated with a same communication group, the method including generating, by the client transmitting entity, a group user key identifier, the group user key identifier being specific to the communication group and being used to encrypt the content, the generation being repeated each time a predetermined event takes place.

### TECHNICAL FIELD OF THE INVENTION

The technical field of the invention is that of telecommunications.

The present invention relates to a method for managing identity by a transmitting entity in a 3GPP MCS network, and in particular for solving security problems unsolved by the standard.

### TECHNOLOGICAL BACKGROUND OF THE INVENTION

The PMR (Professional Mobile Radio) radiocommunication standards TETRAPOL®, TETRA® or P25® allow the implementation of secure professional networks. These narrowband networks are national or local area networks: they are implemented for example within an organisation such as a company, within a country for example for the communications of firemen, police forces, the military etc.

These networks are evolving to support broadband exchanges. The 3GPP standard governing mobile networks of the “GSM” (Global System for Mobile Communications) type, and more particularly in deployments resorting to critical communications services defined by the 3GPP, called “MCS” (for Mission Critical Service), allows for these secure broadband exchanges.

The encryption of voice media MCPTT (Mission Critical Push To Talk) or video MCVideo in a group communication is defined in the TS 33.180 technical specification. It especially implements endpoint diversity.

Any Mission Critical service defined by the 3GPP MCS standard, such as MCVideo, MCData and MCPTT, will hereafter be referred to as “MCX”. A “client” and a server are devices comprising at least a processor and a memory, the memory comprising instructions which, when executed by the processor, cause the user device to perform at least the actions assigned to it. Preferably, a client is a user device. In the same way, a “server” may be a user device. An “MCX client” and an “MCX server” are thus user devices configured to implement Mission Critical services.

When transmitting media from an MCX client, the media transmitted may be encrypted in a transmitter-independent manner. In such a case, the concept of “endpoint diversity” is not implemented. Instead, the implementation of endpoint diversity requires the encryption of the transmitted media by a key specific to the transmitting MCX client. For this, the MCX ID of the user of the transmitting MCX client is used to generate a Group User Key Identifier (GUK-ID). This GUK-ID is used to:
encrypt a media of the SRTP (Secure Real-time Protocol) flow transmitted by the transmitting MCX client and
decrypt this SRTP media flow by the receiving MCX clients.

Procedures in TS 33.180 (clause 7.4.2) technical specification require the transmitting MCX client to include this GUK-ID in a 64-bit SRTP MKI«Master Key Identifier»field transmitted with each SRTP packet. The long format (64-bit) Master

Key Identifier MKI actually comprises a Group Master Key Identifier (GMK-ID) concatenated with the Group User Key Identifier GUK-ID. To create the security association of the communication group within which the media is exchanged, a Group Master Key (GMK) and its associated identifier (GMK-ID) are distributed to the MCX clients of the group by a Group Management Server (GMS).

This procedure also provides the possibility, when the user identity of the transmitting MCX client (which identity is also referred to as “User salt”) is known to the receiving MCX clients, to reduce the SRTP MKI to 32 bits by omitting its GUK-ID component from the transmitter, that is by comprising only the group master key identifier GMK-ID. The GUK-ID group user key identifier is then calculated locally by the receiving MCX clients by performing an XOR “exclusive OR” operation between the user identity of the known transmitting MCX client (“user salt”) and the GMK-ID group master key identifier. In the same way, the group master key identifier GMK-ID can be calculated from the group user key identifier GUK-ID and the known user identity of the transmitting MCX client (“User salt”). However, the identity of the transmitting MCX client user cannot be obtained from the group master key ID GMK-identifier and the group user key identifier GUK-ID, in order to keep some confidentiality.

The identity of the user of the transmitting MCX client can be obtained as it is included in the voice service floor control messages MCPTT, so-called “Floor Control” messages. In MCVideo video service, this information is obtained as it is included in so-called “transmission control” messages. In the MCData data service, there is no endpoint diversity in the 3GPP specifications. In MCData, however, it is possible to retrieve the user identity of the transmitting MCX client from the payload of SIP and/or HTTP messages. SIP is a known Session Initiation Protocol and HTTP (HyperText Transfer Protocol) a known communication protocol. In MCData, this payload is end-to-end encrypted but without endpoint diversity.

In the 3GPP MCS standard, the user identity of the MCX client is transmitted in all call requests and in all floor requests and transmission requests.

This poses a security problem, especially when the 3GPP MCS network extends over several security domains, as it is then possible for a receiving MCX client to identify the user of the transmitting MCX client via its group user key identifier GUK-ID, this identifier being used in the standard to encrypt the content transmitted with endpoint diversity. By “Identify”, it is meant the ability of a receiving client to track the user of the transmitting client, that is when it takes the floor or communicates several times, to link all its floors and communications to the same transmitting client. This principle is called “linkability” and allows a receiving client to obtain key information about the 3GPP MCS network and users composing it. It is also possible, if the receiving client knows a list of potential transmitting client identifiers, to know whether the transmission is coming from one of these users, by testing the different known identities.

There is therefore a need to be able to ensure, in a 3GPP MCS network, that a receiving MCX client cannot identify a transmitting MCX client via its group user key identifier GUK-ID while being able to decrypt the transmitted content encrypted with its group user key identifier GUK-ID.

### SUMMARY OF THE INVENTION

The invention provides a solution to the problems discussed above, by allowing a transmitting client, in a 3GPP MCS (3rd Generation Partnership Program Mission Critical Services) network, to change user identity so that a receiving client can decrypt the transmitted content without being able to link multiple communications from the transmitting client to the transmitting client.

One aspect of the invention relates to a method implemented by a client transmitting entity included in a 3GPP MCS standard network, the client transmitting entity being configured to transmit a plurality of contents intended for at least one client receiving entity included in the network, the client transmitting entity and the client receiving entity being affiliated with a same communication group, the method comprising at least one step of generating, by the client transmitting entity, a group user key identifier GUK-ID, the group user key identifier GUK-ID being specific to the communication group and being used to encrypt the content, the generation step being repeated each time a predetermined event takes place.

By virtue of the invention, it is ensured that the receiving entity of a content transmitted and encrypted by a transmitting entity is able to decrypt the content, without being able to link the communication comprising the content to other communications of the same transmitting entity. For this, the invention comprises randomly generating a group user key identifier GUK-ID of the transmitting entity. Thus, the transmitting entity cannot be “tracked”, that is cannot be linked to its various communications so as to identify that it is a single transmitter, but the 3GPP MCS standard is still met, in that content encryption is performed, with endpoint diversity, with the group user key identifier GUK-ID of the transmitting entity.

Further to the characteristics just discussed in the preceding paragraphs, the method according to one aspect of the invention may have one or more additional characteristics among the following, considered individually or according to any technically possible combinations:
the method further comprises the steps of:
   Encrypting the content to be transmitted, the content being encrypted by the client transmitting entity, encrypting the content being based on a master key according to the Secure Real Time Protocol (SRTP), the master key comprising a group master key identifier (GMK-ID) and the group user key identifier (GUK-ID) generated,
   Transmitting at least one frame to the receiving entity according to the SRTP protocol, the at least one frame comprising the content encrypted.
a plurality of frames are transmitted, each frame of the plurality of frames comprising a part of the content encrypted, the master key being included in the header of a first frame of the plurality of frames.
the predetermined event is the start and/or end of a predetermined time interval, the group user key identifier (GUK-ID) being used to encrypt each of the plurality of contents transmitted during the predetermined time interval.
the predetermined event is the transmission of new content.
the group user key identifier (GUK-ID) is randomly generated.
the communication group is an MCPTT group and the content is a voice communication or an MCVideo group and the content is a video or an MCData group and the content is a textual data set or a file.

Another aspect of the invention relates to a communication network according to the 3GPP MCS “3rd Generation Partnership Program Mission-Critical System” standard, the communication network comprising at least:
a client transmitting entity configured to implement the method according to the invention,
a client receiving entity configured to receive the content encrypted and the master key transmitted by the transmitting entity.

Yet another aspect of the invention is directed to a computer program product comprising instructions that cause the client transmitting entity of the network according to the invention to perform the steps of the method according to the invention.

Yet another aspect of the invention id directed to a computer-readable medium on which the computer program according to the invention is recorded.

The invention and its different applications will be better understood upon reading the following description and upon examining the accompanying figures.

### BRIEF DESCRIPTION OF THE FIGURES

The figures are set forth by way of illustrating and in no way limiting purposes of the invention.

FIG. 1 shows a schematic representation of a network comprising entities configured to implement the method according to the invention,

FIG. 2 shows an example of implementation of the method according to the invention,

FIG. 3 shows a schematic representation of a method according to the invention,

FIGS. 4A and 4B represent a schematic representation of a first embodiment of the method according to the invention,

FIG. 4C shows a schematic representation of a second embodiment of the method according to the invention.

### DETAILED DESCRIPTION

Unless otherwise specified, a same element appearing in different figures has a single reference.

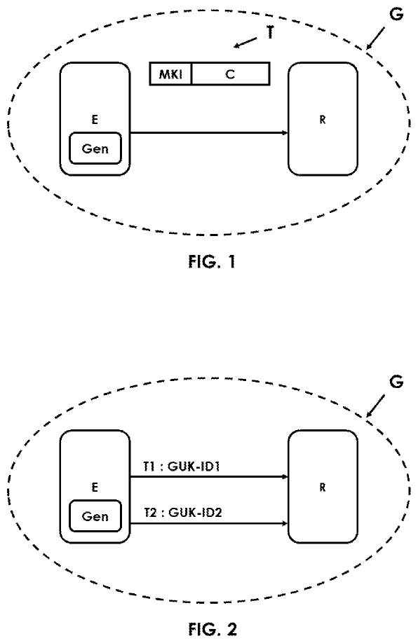

FIG. 1 shows a schematic representation of a network comprising entities configured to implement the method according to the invention.

In particular, the network represented in FIG. 1 comprises a transmitting entity E configured to implement the method according to the invention, and a receiving entity R.

The network represented in FIG. 1 is a network according to the 3GPP MCS standard, that is it is implemented following the specifications defined by the 3GPP MCS standard.

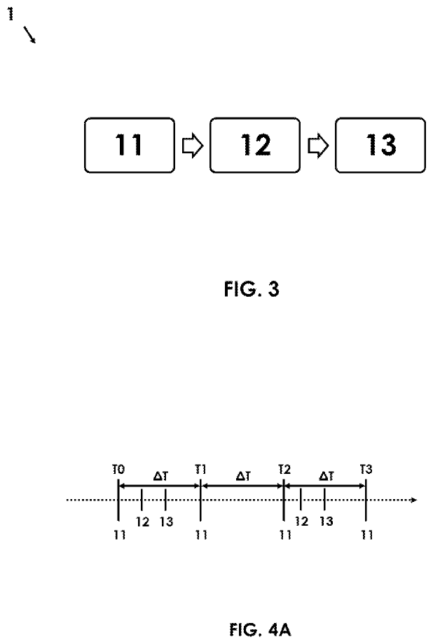

FIG. 3 shows a schematic representation of the method according to the invention. The method represented in FIG. 3 is a method for managing identity according to the invention within the network of FIG. 1.

The network of FIG. 1 comprises a communication group G. The transmitting entity E is affiliated with the communication group G. The receiving entity R is also affiliated with the same communication group G. The communication group G is an MCPTT, MCVideo or MCData communication group as defined in the state of the art.

The transmitting entity E and the receiving entity R may be client or server, participant or non-participant, entities or any other entity defined by the 3GPP MCS standard. The transmitting entity E and the receiving entity R are devices comprising at least a processor and a memory, the memory comprising instructions which, when executed by the processor, cause the processor to implement an action assigned to the entity. For example, the entities may be user devices such as mobile phones, tablets, computers, or any other device usable by a user, or may be computers or devices having the role of a server for the purpose of the 3GPP MCS standard.

The method 1 according to the invention represented in FIG. 3 allows the transmitting entity E to dynamically modify its identity, which identity will be used to encrypt at least one content intended for the receiving entity R. For this, the transmitting entity E comprises at least one identity generation module Gen, making it possible to implement the generation step 11 of the method 1 according to the invention represented in FIG. 3. This module is preferably a software module, implemented by the processor of the transmitting entity.

The invention uses the following key identifiers:
Group user key identifier GUK-ID: this identifier is a key identifier specific to a user of the transmitting entity E and specific to the communication group G. Thus, this key can be seen as a “session key” in the SRTP protocol, as defined in RFC 3711. An identifier of this key, which does not have to remain secret, allows the retrieval of this key, which has to remain secret. This user key is used to encrypt content in the 3GPP MCS standard in the presence of endpoint diversity.
Group master key identifier GMK-ID: This identifier is a group master key identifier specific to the communication group G. In the presence of endpoint diversity, this group master key GMK is used in combination with the group user key GUK to encrypt content as defined in section 7.4.2 of TS 33.180 technical specification.
Master key identifier MKI: This identifier is a master key identifier comprising, in the presence of endpoint diversity, the group user key identifier GUK-ID, and the group master key identifier GMK-ID.

The method 1 according to the invention represented in FIG. 3 comprises at least one step 11 of generating a group user key identifier GUK-ID. This group user key identifier GUK-ID is generated, according to the invention, each time a predetermined event occurs. Thus, it is not possible for a receiving entity R to link the different communications transmitted by the transmitting entity E to the same transmitting entity E, since its normally fixed group user key identifier GUK-ID is regularly modified.

For example, as represented in FIG. 2, a frame T1 will be transmitted comprising content C1 encrypted with a first group user key identifier GUK-ID1 and then a frame T2 will be transmitted comprising content C2 encrypted with another group user key identifier GUK-ID2. The two frames T1 and T2 cannot be linked, by the receiving entity R, to the transmitting entity E since the group user key identifiers GUK-ID1 and GUK-ID2 having served to encrypt the contents C1 and C2 respectively and transmitted in the frames T1 and T2 respectively are different and not linked to the identity of the transmitting entity E.

Preferably, the group user key identifier GUK-ID generated in step 11 is randomly generated. Alternatively, the group user key identifier GUK-ID may be generated according to a predetermined data set, it being important that these data are not linked to the transmitting entity E so that it cannot be identified as the transmitter of the content encrypted with the group user key identifier GUK-ID.

The method according to the invention also comprises a step 12 of encrypting the content C included in the frame T sent to the receiving entity R. The encryption 12 of the content C is performed by the transmitting entity E. The encryption is based on the group user key identifier GUK-ID generated last, that is in the last implementation of the generation step 11, and on the group master key identifier GMK-ID. The encryption 12 is performed using a master key according to the Secure Real Time Protocol (SRTP) at RFC3711 and according to the TS 33.180 technical specification, point 7.5.1, the master key being identified by its master key identifier MKI.

The method 1 according to the invention then comprises a step 13 of transmitting at least one frame T according to the SRTP protocol, from the transmitting entity E to the receiving entity R, the frame T comprising the content C encrypted in step 12 with the group user key identifier GUK-ID generated in step 11. The frame T also includes as a header the master key identifier MKI comprising the group user key identifier GUK-ID generated in step 11 and the group master key identifier GMK-ID. The frame T is then transmitted to the receiving entity R, which uses the information included in the master key identifier MKI and the information available to it by virtue of the network topology and context to decrypt the content C.

In one alternative, the content C encrypted is split into several parts and distributed and sent in a plurality of frames. In this alternative, the master key identifier MKI may only be included in the header of the first frame of the plurality of frames. This saves bandwidth, while still allowing the content to be decrypted.

Step 11 is repeated each time a predetermined event takes place. Steps 12 and 13 are repeated when a content C is to be transmitted. The invention only makes sense when a plurality of contents C are to be transmitted. Indeed, in the case of the transmission of a single content C, the security problem does not exist.

According to the invention, the event leading to a new generation 11 may be:
the start or end of a predetermined time interval, or
a floor or start of a communication.

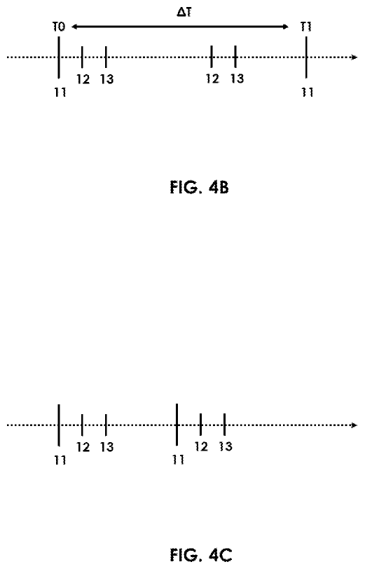

The first case is represented in FIGS. 4A and 4B and the second case is represented in FIG. 4C.

FIGS. 4A and 4B represent a first embodiment, that is the case where the predetermined event is a function of a predetermined time interval. This time interval has for example a duration Δt, the duration of the interval being predetermined, that is set in advance by configuration, for example by virtue of a parameter included in the memory of the transmitting entity E or retrieved from another remote device. The predetermined interval has a duration expressed for example in seconds, minutes, hours or days. Preferably, the predetermined interval is chosen so as to limit the possibilities of identifying a same transmitting entity E, thus so as not to cover, with the same group user key identifier GUK-ID, more than a few content transmissions, for example not more than two content C transmissions or no more than ten content transmissions, or no more than a percentage of the average number of content transmissions over a given period, for example 10%, so as to change ten times the group user key identifier GUK-ID for sending all contents C over said given period.

When, as represented in FIGS. 4A and 4B, the event is a function of a time interval, the step 11 of generating the group user key identifier GUK-ID may be performed for each new interval, for example at the start or end of each interval. The generation step 11 is then performed periodically.

In FIG. 4A, the step 11 of generating the group user key identifier GUK-ID is performed four times at times T0 to T3, while the steps of encrypting the content with the group user key identifier GUK-ID and transmitting 13 the frame comprising the content encrypted and the master key identifier MKI comprising the group user key identifier GUK-ID are performed only twice.

In FIG. 4B, the step 11 of generating the group user key identifier GUK-ID is performed twice at times T0 and T1, while the steps of encrypting the content with the group user key identifier GUK-ID and transmitting 13 the frame comprising the content encrypted and the master key identifier MKI comprising the group user key identifier GUK-ID are performed twice, with the same group user key identifier GUK-ID. These two communications can be linked to the same transmitting entity E, but without having knowledge of its identity. The group user key identifier GUK-ID thereby acts as a “pseudonym”. A new group user key identifier GUK-ID is then generated in step 11 performed at time T1, and subsequent communications (not represented) will not be linkable to the first two communications.

In this first embodiment, generating 11 the group user key identifier GUK-ID is not directly linked to the transmission of content from the transmitting entity E to the receiving entity R, since it is performed according to a time condition.

In one alternative to the first embodiment, the duration of the predetermined interval may be variable, that is Δt is not fixed.

FIG. 4C represents a second embodiment in which the predetermined event is dependent on the initiation of a communication. In this second embodiment, generating 11 the group user key identifier GUK-ID is performed on each floor in MCPTT, on each video content transmission in MCVideo, or on each text or file data transmission in MCData. Thus, in this second embodiment, the receiving entity R cannot gather any communication with others and cannot link them with the transmitting entity E. The receiving entity R can still decrypt the content since it receives, in the master key identifier MKI, the group user key identifier GUK-ID used to encrypt the content with the group master key identifier GMK-ID.

1. A method implemented by a client transmitting entity included in a network according to the 3GPP MCS standard, the client transmitting entity being configured to transmit a plurality of contents intended for at least one client receiving entity included in the network, the client transmitting entity and the client receiving entity being affiliated with a same communication group, the method comprising generating, by the client transmitting entity, a group user key identifier, the group user key identifier being specific to the communication group and being used to encrypt the content, the generating being repeated each time a predetermined event takes place.

2. The method according to claim 1, further comprising:
encrypting the content to be transmitted, the content being encrypted by the client transmitting entity, encrypting the content being based on a master key according to the Secure Real Time Protocol, the master key comprising a group master key identifier and the group user key identifier generated,
transmitting at least one frame to the receiving entity, according to the SRTP protocol, the at least one frame comprising the content encrypted.

3. The method according to claim 1, wherein a plurality of frames are transmitted, each frame of the plurality of frames comprising a part of the content encrypted, the master key being included in the header of a first frame of the plurality of frames.

4. The method according to claim 1, wherein the predetermined event is a start and/or end of a predetermined time interval, the group user key identifier being used to encrypt each of a plurality of contents transmitted during the predetermined time interval.

5. The method according to claim 1, wherein the predetermined event is the transmission of a new content.

6. The method according to claim 1, wherein the group user key identifier is randomly generated.

7. The method according to claim 1, wherein the communication group is
an MCPTT group and the content is a voice communication or
an MCVideo group and the content is a video or
an MCData group and the content is a textual data set or a file.

8. A communication network according to the 3GPP MCS (3rd Generation Partnership Program Mission-Critical System) standard, the communication network comprising:
a client transmitting entity configured to implement the method according to claim 1,
a client receiving entity configured to receive the content encrypted and master key transmitted by the transmitting entity.

9. (canceled)

10. A non-transitory computer-readable medium, comprising machine readable instructions for performing the method of claim 1.
